(19) United States
(12) Patent Application Publication
(10) Pub. No.: US 2011/0232417 A1
(43) Pub. Date: Sep. 29, 2011

(54) Drive device with human power bidirectional input in constant rotary direction and same speed ratio

(76) Inventor: Tai-Her Yang, Dzan-Hwa (TW)

(21) Appl. No.: 12/659,842

(22) Filed: Mar. 23, 2010

(51) Int. Cl. F16H 35/00

(52) U.S. Cl. 74/640

(57) ABSTRACT

The present invention is related to a manpower driven device being able to perform specific bi-directional pedaling to provide constant directional output for driving the loading wheel train thereof, wherein its pedaling direction is selected by the rider according to his/her operating statuses of the muscles and joints, or further through the input in different driving directions to perform output in the same directional rotation and same speed ratio.

### BACKGROUND OF THE INVENTION

(a) Field of the Invention

The present invention discloses a device being able to perform bi-directional rotation of positive or reverse rotation by both or one of the human hand or foot to drive the input end of the manpower-driven input device, and then through the output end of the manpower-driven input device to the input end of the constant directional rotation output transmission device with same speed ratio, and further via the output end of the constant directional rotation output transmission device with same speed ratio to provide constant directional rotation and same speed ratio output thereby to drive the loading wheel trains, wherein the present invention can be applied in bi-directional manpower-driven carriers including foot pedaling driven vehicles, or hand rotating driven vehicles, or both or one of the pedaling and hand rotating driven vehicles; or can be applied in bi-directional manpower-driven exercise devices including foot pedaling driven exercise devices, or hand rotating driven exercise devices, or both or one of the pedaling and hand rotating driven exercise devices; or can be applied in generally driven fluid pumps, or fans or generating devices including foot pedaling driven devices, or hand rotating driven devices, or both or one of the pedaling and hand rotating vehicles driven devices.

(b) Description of the Prior Art

We all know that the bicycle rider is always pedaling in constant directions using the relevant muscles and joints periodically and constantly; i.e part of the muscles and joints of pedaler's body are always at force exerting and receiving statuses, while the other part of muscles and joints of the pedaler's body are always at non-force exerting and receiving statuses; therefore, loading on the human body is unevenly distributed, and the rider may incur sport hazard due to tiredness of longtime stepping movement.

### SUMMARY OF THE INVENTION

The present invention discloses a manpower-driven device having a particular man-power driven device being able to perform bi-directional rotational input having its output ends for providing output to the input ends of the constant directional rotation output transmission device with same speed ratio, while the constant directional rotation and same speed ratio output is used to drive the loading wheel train via the output end of the constant directional rotation output transmission device with same speed ratio, wherein the direction of the driving input can be freely selected by the user, and by means of the constant directional rotation output transmission devices with same speed ratio to perform constant directional rotation and same speed ratio output under different driving input directions.

The present invention is especially applied to a bidirectional pedaling bicycle or to a bidirectional pedaling exercise device for lower limbs bidirectional pedaling, thereby to widen the use of muscles and change the muscle strength and density, and obtain the following advantages:
(1) reducing injuries caused by overuse of partial muscles and joints;
(2) working or training the muscles and joints seldom being used;
(3) avoiding the joints from impact caused by the inertia of the load because of the instant reverse rotation of the load at the reversely pedaling moment.

Above advantages can be applied to various bidirectional manpower driving using different muscle groups; especially when apply the bidirectional pedaling driving to bicycles or pedaling exercise devices, the difference of the muscle groups using for bidirectional pedaling is larger, that makes the said advantages and their effects more obvious. (Please refer to the analysis and description of attachment.)

### BRIEF DESCRIPTION OF THE DRAWINGS

FIG. 1 is a basic block schematic view of the drive device with human power bidirectional input in constant rotary direction and same speed ratio, according to the present invention.

FIG. 2 is a block schematic view showing that the driving device in FIG. 1 is additionally installed with a transmission device (104) between the manpower input device (101) and constant directional rotation output transmission device with same speed ratio (102).

FIG. 3 is a block schematic view showing that the driving device in FIG. 1 is additionally installed with a transmission device (104) between constant directional rotation output transmission device with same speed ratio (102) and the driven loading wheel train (103).

FIG. 4 is a block schematic view showing that the driving device in FIG. 1 is additionally installed with a transmission device (104) between manpower input device (101) and constant directional rotation output transmission device with same speed ratio (102) as well as between constant directional rotation output transmission device with same speed ratio (102) and the driven loading wheel train (103).

FIG. 5 is a structural block schematic view of the invention being applied in a manpower driven sport device having loading wheel train of fixed damping.

FIG. 6 is a structural block schematic view of the invention being applied in a manpower driven sport device having loading wheel trains with operatively controllable damping.

FIG. 7 is a structural block schematic view of the invention being applied in a manpower driven carrier which is externally installed with a fixed damping device for producing damping thereby constituting sport device functions.

FIG. 8 is a structural block schematic view of the invention being applied in a manpower driven carrier which is externally installed with an operatively controllable damping device (105) thereby constituting sport device functions.

FIG. 9 is a structural block schematic view of the mechanical functioning device of the invention being driven in constant directional rotation.

FIG. 10 is a structural block schematic view of the invention for driving the power generator.

FIG. 11 is a structural block schematic view of the integrally combined structure of the driven loading wheel train (103) and the power generator (109) of the invention.

FIG. 12 is a structural block schematic view of the invention showing that loading wheel train (103) of manpower driven carrier is equipped with the power generator (109).

### DESCRIPTION OF MAIN COMPONENT SYMBOLS

101: Manpower input device
102: Constant directional rotation output transmission device with same speed ratio
103: Loading wheel train
104-200: Transmission device
105: Externally installed operatively controllable damping device
106: Loading wheel train with fixed damping
107: Loading wheel train with operatively controllable damping
108: Rotation type mechanical functioning device
109: Power generator set
110: Operative control device relative to power generator
111: Circuit switch and protective device
112: Externally installed fixed damping device

### DETAILED DESCRIPTION OF THE PREFERRED EMBODIMENTS

The present invention discloses a device being able to perform bi-directional rotation of positive or reverse rotation by both or one of the human hand or foot to drive the input end of the manpower-driven input device, and then through the output end of the manpower-driven input device to the input end of the constant directional rotation output transmission device with same speed ratio, and further via the output end of the constant directional rotation output transmission device with same speed ratio to provide constant directional rotation and same speed ratio output thereby to drive the loading wheel trains, wherein the present invention can be applied in bi-directional manpower-driven carriers including foot pedaling driven vehicles, or hand rotating driven vehicles, or both or one of the pedaling and hand rotating driven vehicles; or can be applied in bi-directional manpower-driven exercise devices including foot pedaling driven exercise devices, or hand rotating driven exercise devices, or both or one of the pedaling and hand rotating driven exercise devices;

or can be applied in generally driven fluid pumps, or fans or generating devices including foot pedaling driven devices, or hand rotating driven devices, or both or one of the pedaling and hand rotating vehicles driven devices; the present invention is especially applied to a bidirectional pedaling bicycle or to a bidirectional pedaling exercise device for lower limbs bidirectional pedaling, thereby to widen the use of muscles and change the muscle strength and density, and obtain the following advantages:
(1) reducing injuries caused by overuse of partial muscles and joints;
(2) working or training the muscles and joints seldom being used;
(3) avoiding the joints from impact caused by the inertia of the load because of the instant reverse rotation of the load at the reversely pedaling moment.

Above advantages can be applied to various bidirectional manpower driving using different muscle groups; especially when apply the bidirectional pedaling driving to bicycles or pedaling exercise devices, the difference of the muscle groups using for bidirectional pedaling is larger, that makes the said advantages and their effects more obvious.

The present invention discloses a manpower-driven device having a particular man-power driven device being able to perform bi-directional rotational input having its output ends for providing output to the input ends of the constant directional rotation output transmission device with same speed ratio, while the constant directional rotation and same speed ratio output is used to drive the loading wheel train via the output end of the constant directional rotation output transmission device with same speed ratio, wherein the direction of the driving input can be freely selected by the user, and by means of the constant directional rotation output transmission devices with same speed ratio to perform constant directional rotation and same speed ratio output under different driving input directions.

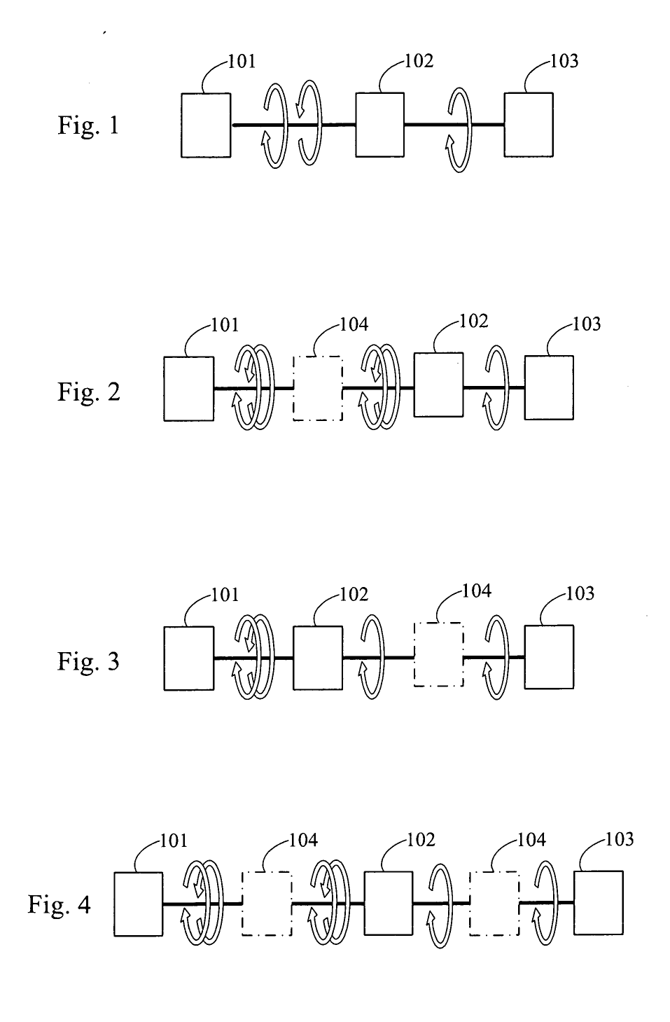

FIG. 1 is a basic block schematic view of the drive device with human power bidirectional input in constant rotary direction and same speed ratio, according to the present invention.

FIG. 2 is a block schematic view showing that the driving device in FIG. 1 is additionally installed with a transmission device (104) between the manpower input device (101) and constant directional rotation output transmission device with same speed ratio (102).

FIG. 3 is a block schematic view showing that the driving device in FIG. 1 is additionally installed with a transmission device (104) between the constant directional rotation output transmission device with same speed ratio (102) and the driven loading wheel train (103).

FIG. 4 is a block schematic view showing that the driving device in FIG. 1 is additionally installed with a transmission device (104) between the manpower input device (101) and the constant directional rotation output transmission device with same speed ratio (102) as well as between the constant directional rotation output transmission device with same speed ratio (102) and the driven loading wheel train (103).

For the drive device with human power bidirectional input in constant rotary direction and same speed ratio, the manpower input device (101) is driven by both or one of the human hand or foot in the first driven rotating direction or in the second driven rotating direction of contrary rotating direction, wherein the rotational kinetic energy output from the output end of the manpower input device (101) is directly, or through the transmission device (104), provided to the input end of the constant directional rotation output transmission device with same speed ratio (102), and the kinetic energy in constant rotary direction and same speed ratio is output from the output end of the constant directional rotation output transmission device with same speed ratio (102) to drive the loading wheel train (103); as shown in FIG. 1˜FIG. 4, wherein:

The manpower input device (101): it is constituted by the bi-directional rotation output mechanism which receives the positive or reverse bi-directional rotation or reciprocation driving input by both or one of the hand or foot of human body to produce the selected speed ratio and corresponding positive or reverse rotation, including constituted by the pedal, crankshaft and bi-directional rotation transmission wheel train, or constituted by the handle, handle shaft, and bi-directional rotation transmission wheel train, or constituted by the conventional manpower-driven mechanism using manpower to produce bi-directional rotation driving;

The input kinetic energy to drive the first driven rotating direction and the second driven rotating direction comes from both or one of the human hand or foot for driving the input end of the manpower input device (101);

The first driven rotating direction is contrary to the second driven rotating direction;

The constant directional rotation output transmission device with same speed ratio (102): the constant rotating directional transmission device with same speed ratio (102) directly, or through the transmission device (104), receives different rotating directional energy from the manpower input device (101) so as to provide kinetic energy output in constant directional rotation with the same speed ratio; wherein the internal transmission component of the constant directional rotation output transmission device with same speed ratio (102) are constituted by one or more than one kind of transmission components including: 1)gear train; or 2) friction wheel train; or 3) chain and chain sprocket train; or 4) belt and belt wheel train; or 5) transmission crankshaft and wheel train; or 6) fluid transmission device; or 7) electromagnetic transmission device, etc., wherein if the constant rotating directional transmission device with same speed ratio (102) is driven by the inputs of the first driven rotating direction and second driven rotating direction in different rotating directions, and the speed ratio of the constant directional rotation between the input end and the output end is the same, the speed ratio can be constant or variable;

The loading wheel train (103): it is the wheel train type load being directly driven by the output end of the constant directional rotation output transmission device with same speed ratio (102) or being driven in the single constant directional rotation via the transmission device (104);

The transmission device (104): the transmission device (104) is constituted by one or more than one kind of transmission devices of the following, including: 1) various gear-type, belt-type, friction-type fixed speed ratio or variable-speed ratio rotating type transmission functioning structure, or 2) a stepped or stepless variable speed device being operated manually, or by the mechanical force, or fluid force, or centrifugal force, or rotating torque or counter-rotating torque, or 3) the transmission device of the capability to operatively control and switch the relationship of the relative rotating directions at the input end and the output end, or 4) the clutch device or the single way clutch being operated manually, or by the mechanical force, or electromagnetic force, or fluid force, or centrifugal force, or rotating torque, or counter-rotating torque, for the clutch-functioned device performing connecting transmission or interrupting transmission;

The drive device with human power bidirectional input in constant rotary direction and same speed ratio includes the application to the bi-directional rotation manpower driven carrier being driven by both or one of the human hand or foot, wherein the bi-directional rotational kinetic energy output from the output end of the manpower input device (101) being driven by both or one of the human hand or foot for positive or reverse rotation is directly provided or provided via the transmission device (104) to at least one constant directional rotation output transmission device with same speed ratio (102), and the loading wheel train (103) is directly driven or driven via the transmission device (104) by the rotational kinetic energy in the constant directional rotation and same speed ratio output from the output end of the constant directional rotation output transmission device with same speed ratio (102), while the manpower input device (101) is positively or reversely driven by both or one of the human hand or foot to provide output in relative rotational direction according to selected speed ratio.

The drive device with human power bidirectional input in constant rotary direction and same speed ratio being applied to manpower driven carriers is constituted by the manpower driven carrier including foot pedaling driven vehicles, or hand rotating driven vehicles, or both foot pedaling and hand rotating driven vehicles equipped with at least one wheel train, thereby by means of both or one of the human hand or foot to perform positive or reverse rotation to drive the manpower input device (101), and further to output positive or reverse rotational kinetic energy from the output end to directly or via the transmission device (104) to the input end of the constant directional rotation output transmission device with same speed ratio (102), and then the output end of the constant directional rotation output transmission device with same speed ratio (102) performs the constant directional rotation and same speed ratio output to further directly or via the transmission device (104) drive the loading wheel train (103), thereby to further drive the carrier being combined with the loading wheel train (103).

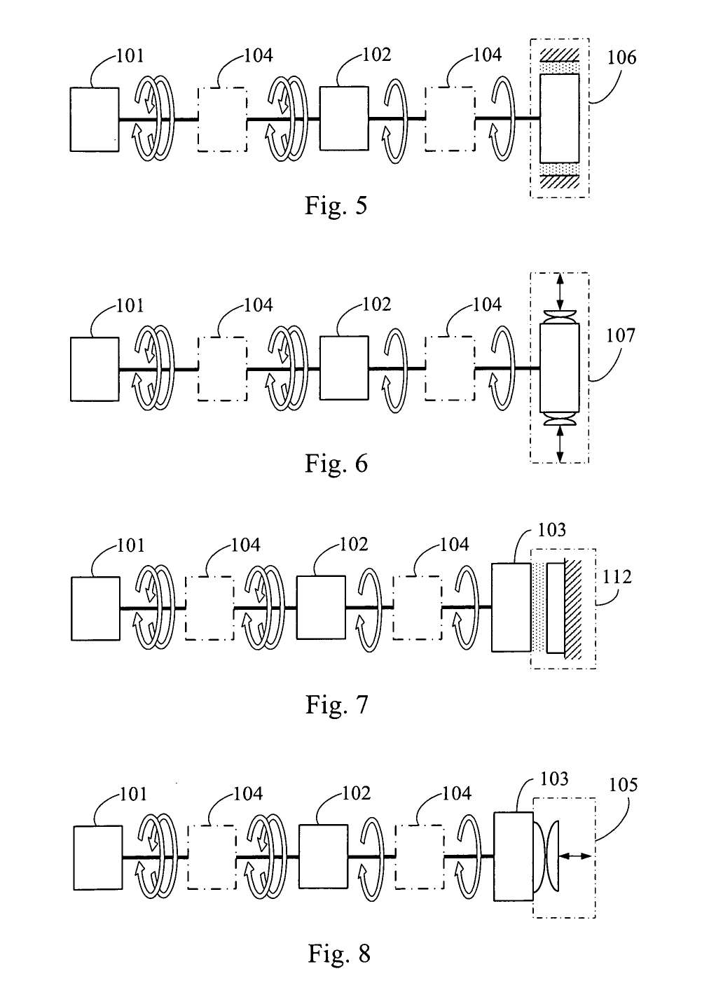

The drive device with human power bidirectional input in constant rotary direction and same speed ratio can be further applied to the manpower driven exercise devices, such as health exercise bicycles, as illustrated in FIG. 5 is a structural block schematic view of the invention being applied in a manpower driven exercise device having the loading wheel train with fixed damping, wherein it includes the constitution of the manpower input device (101) being driven by both or one of the human hand or foot for positive or reverse rotation and at least one constant directional rotation output transmission device with same speed ratio (102) with the input ends whereof to directly receive or via the transmission device (104) to receive the rotational kinetic energy output from the manpower input device (101) and then via the output end of the constant directional rotation output transmission device with same speed ratio (102) to perform constant directional rotation output, whereby the output rotational kinetic energy is directly or via the transmission device (104) to drive the loading wheel train with fixed damping (106), while the loading wheel train with fixed damping (106) has a fixed damping for production during operation of the exercise device;

The fixed damping of aforesaid loading wheel train with fixed damping (106) includes the constitutions of friction type, fluid type, counter-torque of power generation output type, electrical counter-torque type, or electromagnetic eddy current generating type fixed damping structures.

The drive device with human power bidirectional input in constant rotary direction and same speed ratio can be further applied to the manpower driven exercise devices having operatively controllable damping devices, such as health exercise bicycles, as illustrated in FIG. 6 is a structural block schematic view of the invention being applied in a manpower driven exercise device having loading wheel trains with operatively controllable damping, wherein it includes the constitution of the manpower input device (101) being driven by both or one of the human hand or foot and at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train with operatively controllable damping (107), while the loading wheel train with operatively controllable damping (107) has the operative control function to produce operatively controllable damping function during operation of the exercise device;

The operatively controllable damping of aforesaid loading wheel train with operatively controllable damping (107) includes the constitutions of friction type, fluid type, counter-torque of power generation output type, electrical counter-torque type, or electromagnetic eddy current generating type damping structures having operative control functions, etc. for operatively controlling the damping of loading wheel train with operatively controllable damping (107).

The operatively controlled method of the aforesaid loading wheel train with operatively controllable damping (107) is by means of the fluidic, mechanical or electrical operative control methods and devices, according to the type of selected damping structure, to operatively control the loading wheel train with operatively controllable damping (107) to produce the operatively controllable damping functions.

The drive device with human power bidirectional input in constant rotary direction and same speed ratio is through additionally externally installed with the fixed damping device (112) on the manpower driven carrier to produce damping effect on the loading wheel train (103) for conversion to exercise device functions use; as illustrated in FIG. 7 is a structural block schematic view of the invention being applied in a manpower driven carrier which is externally installed with a fixed damping device for producing damping thereby constituting exercise device functions, wherein it includes the constitution of the manpower input device (101) being driven by both or one of the human hand or foot and at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train (103), while the loading wheel train (103) is additionally externally installed with at least one fixed damping device (112) for producing damping during the exercise device functional operation.

The damping structure of the externally installed fixed damping device (112) on the loading wheel train (103) for producing damping effect includes the constitutions of friction type, fluid type, counter-torque of power generation output type, electrical counter-torque type, or electromagnetic eddy current generating type damping structures with operatively controllable features.

The drive device with human power bidirectional input in constant rotary direction and same speed ratio is through externally installed with an operatively controllable damping device (105) on the manpower driven carrier for conversion to exercise device functional use; as illustrated in FIG. 8 is a structural block schematic view of the invention being applied in a manpower driven carrier which is externally installed with an operatively controllable damping device (105) thereby constituting exercise device functions, wherein it includes the constitution of the manpower input device (101) being driven by both or one of the human hand or foot and having at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train (103), while the loading wheel train (103) is externally installed with at least one operatively controllable damping device (105) for producing operatively controllable damping during the exercise device functional operation;

The damping structure of the externally installed operatively controllable damping device (105) includes the constitutions of friction type, fluid type, counter-torque of power generation output type, electrical counter-torque type, or electromagnetic eddy current generating type damping structures with operatively controllable features, wherein the damping capacity during exercise device functional operation is operatively controlled via the fluidic, mechanical or electrical operative control methods and devices by the externally installed operatively controllable damping device (105) according to the type of selected damping structure.

The drive device with human power bidirectional input in constant rotary direction and same speed ratio is through the manpower to provide positive or reserve rotational kinetic energy to the input end of the manpower input device (101), and the rotational kinetic energy output from the output end of the manpower input device (101) is transmitted to the input end of the constant directional rotation output transmission device with same speed ratio (102), while the mechanical output power in constant rotating direction being exported from the output end of the constant directional rotation output transmission device with same speed ratio (102) is used to drive the mechanical functioning device in constant rotating direction, as illustrated in FIG. 9 is a structural block schematic view of the mechanical functioning device of the invention being driven in constant directional rotation, wherein it includes the constitution of the manpower input device (101) being driven by both or one of the human hand or foot for positive or reverse rotation and having the constant directional rotation output transmission device with same speed ratio (102) with the input end whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the rotating type mechanical functioning device (108) such as the fluid pump, or fan, or flywheel of inertia storage, or other manpower driven rotating type mechanical functioning device (108);

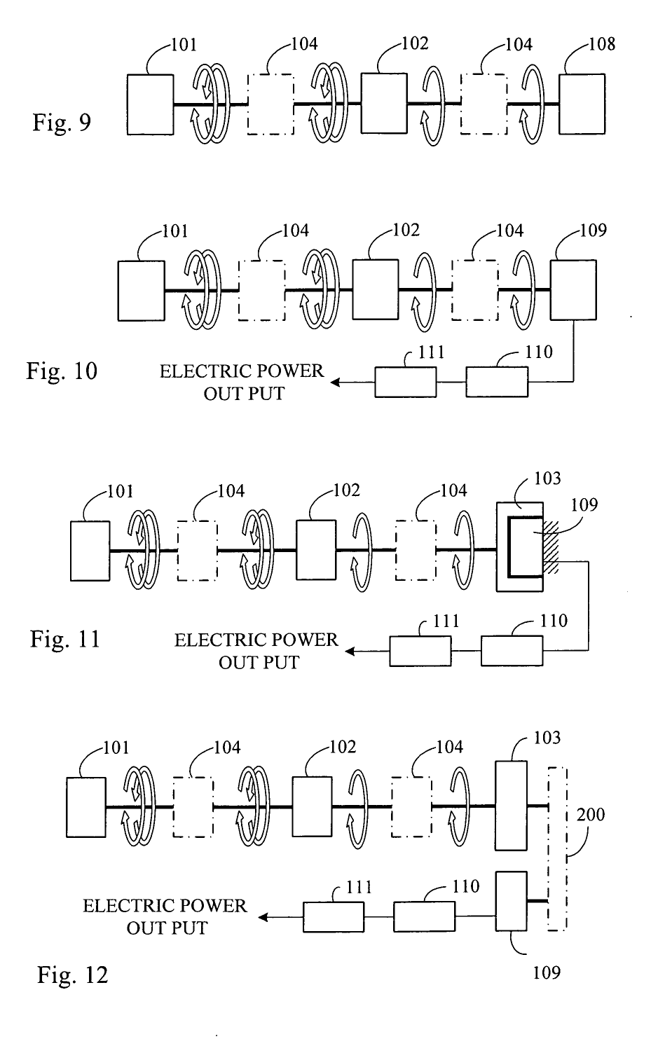

The drive device with human power bidirectional input in constant rotary direction and same speed ratio is further through the manpower to provide positive or reserve rotational kinetic energy to the input end of the manpower input device (101), and the rotational kinetic energy output from the output end of the manpower input device (101) is transmitted to the input end of the constant directional rotation output transmission device with same speed ratio (102), while the constant directional rotation output being exported from the output end of the constant directional rotation output transmission device with same speed ratio (102) is used to drive the power generator (109), as illustrated in FIG. 10 is a structural block schematic view of the invention for driving the power generator, wherein it includes the constitution of the manpower input device (101) being driven by both or one of the human hand or foot for positive or reverse rotation and having the constant directional rotation output transmission device with same speed ratio (102) with the input end whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive rotating type power generator (109), while the power generator (109) can be further optionally installed with the relevant operative control device (110) and the electrical circuit switches or protective devices (111) as needed.

The drive device with human power bidirectional input in constant rotary direction and same speed ratio being applied to drive the power generator (109) further includes to combine the loading wheel train (103) and the power generator (109) as an integrally structure, as illustrated in FIG. 11 is a structural block schematic view of the integrally combined structure of the driven loading wheel train (103) and the power generator (109) of the invention, wherein it includes the constitution of the manpower input device (101) being driven by both or one of the human hand or foot for positive or reverse rotation, and the rotational kinetic energy output from the output end of the manpower input device (101) is directly or via the transmission device (104) transmitted to the input end of the constant directional rotation output transmission device with same speed ratio (102), and then is outputted in the constant rotational direction from the output end of the constant directional rotation output transmission device with same speed ratio (102) for driving the power generator (109), whereby the power generator (109) and the loading wheel train (103) is combined integrally, or the power generator (109) is directly constituted by the loading wheel train (103) as part of the power generation structure, ; the power generator (109) can be further optionally installed with the relevant operative control device (110) and the electrical circuit switches or protective devices (111) as needed.

The drive device with human power bidirectional input in constant rotary direction and same speed ratio being used for manpower driven carrier is further installed with the power generator (109) which is directly driven or driven via the transmission device (200) by the loading wheel train (103), as illustrated in FIG. 12 is a structural block schematic view of the invention showing that loading wheel train (103) of the manpower driven carrier is equipped with the power generator (109), wherein it includes the constitution of the manpower input device (101) being driven by both or one of the human hand or foot for positive or reverse rotation, and the rotational kinetic energy output from the output end of the manpower input device (101) is directly or via the transmission device (104) transmitted to the input end of the constant directional rotation output transmission device with same speed ratio (102), and then is outputted in the constant rotational direction from the output end of the constant directional rotation output transmission device with same speed ratio (102) for driving the loading wheel train (103), thereby to drive the power generator (109) by the loading wheel train (103), while the power generator (109) is externally installed to be subject to be driven by the loading wheel train (103), whereby the power generator (109) can be further optionally installed with the relevant operative control device (110) and the electrical circuit switches or protective devices (111) as needed.

The present invention is especially applied to a bidirectional pedaling bicycle or to a bidirectional pedaling exercise device for lower limbs bidirectional pedaling, thereby to widen the use of muscles and change the muscle strength and density, and obtain the following advantages:
(1) reducing injuries caused by overuse of partial muscles and joints;
(2) working or training the muscles and joints seldom being used;
(3) avoiding the joints from impact caused by the inertia of the load because of the instant reverse rotation of the load at the reversely pedaling moment.

Above advantages can be applied to various bidirectional manpower driving using different muscle groups; especially when apply the bidirectional pedaling driving to bicycles or pedaling exercise devices, the difference of the muscle groups using for bidirectional pedaling is larger, that makes the said advantages and their effects more obvious.

The drive device with human power bidirectional input in constant rotary direction and same speed ratio being used as the bi-directional manpower-driven carrier, or the bi-directional manpower-driven exercise device, or the bi-directional manpower-driven rotating type mechanical functioning device, or the bi-directional manpower-driven power generator is further optionally additionally installed with the displaying device of relevant operating functions, or the detector device or displaying device of operator's psychological condition according to properties of the driven load.

1. A drive device with human power bidirectional input in constant rotary direction and same speed ratio is applied to a bidirectional pedaling device with upper human body closer to vertical status, wherein the manpower input device (101) is driven by both or one of the human hand or foot in the first driven rotating direction or in the second driven rotating direction of contrary rotating direction, wherein the rotational kinetic energy output from the output end of the manpower input device (101) is directly provided or via the transmission device (104) to provide to the input end of the constant directional rotation output transmission device with same speed ratio (102), and the rotational kinetic energy output in constant rotating direction and same speed ratio from the output end of the constant directional rotation output transmission device with same speed ratio (102) is used to drive the loading wheel train (103), including:
The manpower input device (101): it is constituted by the bi-directional rotation output mechanism which receives the positive or reverse bi-directional rotation or reciprocation driving input by both or one of the hand or foot of human body to produce the selected speed ratio and corresponding positive or reverse rotation, including constituted by the pedal, crankshaft and bi-directional rotation transmission wheel train, or constituted by the handle, handle shaft, and bi-directional rotation transmission wheel train, or constituted by the conventional manpower-driven mechanism using manpower to produce bi-directional rotation driving;
The input kinetic energy to drive the first driven rotating direction and the second driven rotating direction comes from both or one of the human hand or foot for driving the input end of the manpower input device (101);
The first driven rotating direction is contrary to the second driven rotating direction;
The constant directional rotation output transmission device with same speed ratio (102): the constant rotating directional transmission device with same speed ratio (102) directly, or through the transmission device (104), receives different rotating directional energy from the manpower input device (101) so as to provide kinetic energy output in constant directional rotation with the same speed ratio; wherein the internal transmission component of the constant directional rotation output transmission device with same speed ratio (102) are constituted by one or more than one kind of transmission components including: 1)gear train; or 2) friction wheel train; or 3) chain and chain sprocket train; or 4) belt and belt wheel train; or 5) transmission crankshaft and wheel train; or 6) fluid transmission device; or 7) electromagnetic transmission device, etc., wherein if the constant rotating directional transmission device with same speed ratio (102) is driven by the inputs of the first driven rotating direction and second driven rotating direction in different rotating directions, and the speed ratio of the constant directional rotation between the input end and the output end is the same, the speed ratio can be constant or variable;
The loading wheel train (103): it is the wheel train type load being directly driven by the output end of the constant directional rotation output transmission device with same speed ratio (102) or being driven in the single constant directional rotation via the transmission device (104);
The transmission device (104): it is the wheel train type load being directly driven by the output end of the constant directional rotation output transmission device with same speed ratio (102) or being driven in the single constant directional rotation via the transmission device (104);
The transmission device (104): the transmission device (104) is constituted by one or more than one kind of transmission devices of the following, including: 1) various gear-type, belt-type, friction-type fixed speed ratio or variable-speed ratio rotating type transmission functioning structure, or 2) a stepped or stepless variable speed device being operated manually, or by the mechanical force, or fluid force, or centrifugal force, or rotating torque or counter-rotating torque, or 3) the transmission device of the capability to operatively control and switch the relationship of the relative rotating directions at the input end and the output end, or 4) the clutch device or the single way clutch being operated manually, or by the mechanical force, or electromagnetic force, or fluid force, or centrifugal force, or rotating torque, or counter-rotating torque, for the clutch-functioned device performing connecting transmission or interrupting transmission.

2. A drive device with human power bidirectional input in constant rotary direction and same speed ratio as claimed in claim 1, wherein it includes the application to the bi-directional rotation manpower driven carrier being driven by both or one of the human hand or foot, wherein the bi-directional rotational kinetic energy output from the output end of the manpower input device (101) being driven by both or one of the human hand or foot for positive or reverse rotation is directly provided or provided via the transmission device (104) to at least one constant directional rotation output transmission device with same speed ratio (102), and the loading wheel train (103) is directly driven or driven via the transmission device (104) by the rotational kinetic energy in the constant directional rotation and same speed ratio output from the output end of the constant directional rotation output transmission device with same speed ratio (102), while the manpower input device (101) is positively or reversely driven by both or one of the human hand or foot to provide output in relative rotational direction according to selected speed ratio.

3. A drive device with human power bidirectional input in constant rotary direction and same speed ratio as claimed in claim 2, wherein it is applied to the manpower driven carrier, and is constituted by the manpower driven carriers including foot pedaling driven vehicles, or hand rotating driven vehicles, or both foot pedaling and hand rotating driven vehicles equipped with at least one wheel train, thereby by means of both or one of the human hand or foot to perform positive or reverse rotation to drive the manpower input device (101), and further to output positive or reverse rotational kinetic energy from the output end to directly or via the transmission device (104) to the input end of the constant directional rotation output transmission device with same speed ratio (102), and then the output end of the constant directional rotation output transmission device with same speed ratio (102) performs the constant directional rotation and same speed ratio output to further directly or via the transmission device (104) drive the loading wheel train (103), thereby to further drive the carrier being combined with the loading wheel train (103).

4. A drive device with human power bidirectional input in constant rotary direction and same speed ratio as claimed in claim 1, wherein it can be further applied to the manpower driven exercise devices, and it includes the constitution of the manpower input device (101) being driven by both or one of the human hand or foot for positive or reverse rotation and at least one constant directional rotation output transmission device with same speed ratio (102) with the input ends whereof to directly receive or via the transmission device (104) to receive the rotational kinetic energy output from the manpower input device (101) and then via the output end of the constant directional rotation output transmission device with same speed ratio (102) to perform constant directional rotation output, whereby the output rotational kinetic energy is directly or via the transmission device (104) to drive the loading wheel train with fixed damping (106), while the loading wheel train with fixed damping (106) has a fixed damping for production during operation of the exercise device;
the fixed damping of aforesaid loading wheel train with fixed damping (106) includes the constitutions of friction type, fluid type, counter-torque of power generation output type, electrical counter-torque type, or electromagnetic eddy current generating type fixed damping structures.

5. A drive device with human power bidirectional input in constant rotary direction and same speed ratio as claimed in claim 1, wherein it can be further applied to the manpower driven exercise devices having operatively controllable damping devices, and it includes the constitution of the manpower input device (101) being driven by both or one of the human hand or foot and at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train with operatively controllable damping (107), while the loading wheel train with operatively controllable damping (107) has the operative control function to produce operatively controllable damping function during operation of the exercise device;
the operatively controllable damping of aforesaid loading wheel train with operatively controllable damping (107) includes the constitutions of friction type, fluid type, counter-torque of power generation output type, electrical counter-torque type, or electromagnetic eddy current generating type damping structures having operative control functions, etc. for operatively controlling the damping of loading wheel train with operatively controllable damping (107);
the operatively controlled method of the aforesaid loading wheel train with operatively controllable damping (107) is by means of the fluidic, mechanical or electrical operative control methods and devices, according to the type of selected damping structure, to operatively control the loading wheel train with operatively controllable damping (107) to produce the operatively controllable damping functions.

6. A drive device with human power bidirectional input in constant rotary direction and same speed ratio as claimed in claim 1, wherein it is through additionally externally installed with the fixed damping device (112) on the manpower driven carrier to produce damping effect on the loading wheel train (103) for conversion to exercise device functions use, and it includes the constitution of the manpower input device (101) being driven by both or one of the human hand or foot and at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train (103), while the loading wheel train (103) is additionally externally installed with at least one fixed damping device (112) for producing damping during the exercise device functional operation;
the damping structure of the externally installed fixed damping device (112) on the loading wheel train (103) for producing damping effect includes the constitutions of friction type, fluid type, counter-torque of power generation output type, electrical counter-torque type, or electromagnetic eddy current generating type damping structures with operatively controllable features.

7. A drive device with human power bidirectional input in constant rotary direction and same speed ratio as claimed in claim 1, wherein it includes the constitution of the manpower input device (101) being driven by both or one of the human hand or foot and having at least one constant directional rotation output transmission device with same speed ratio (102) with the input ends whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the loading wheel train (103), while the loading wheel train (103) is externally installed with at least one operatively controllable damping device (105) for producing operatively controllable damping during the exercise device functional operation;
the damping structure of the externally installed operatively controllable damping device (105) includes the constitutions of friction type, fluid type, counter-torque of power generation output type, electrical counter-torque type, or electromagnetic eddy current generating type damping structures with operatively controllable features, wherein the damping capacity during exercise device functional operation is operatively controlled via the fluidic, mechanical or electrical operative control methods and devices by the externally installed operatively controllable damping device (105) according to the type of selected damping structure.

8. A drive device with human power bidirectional input in constant rotary direction and same speed ratio, wherein it can be through the manpower to provide positive or reserve rotational kinetic energy to the input end of the manpower input device (101), and the rotational kinetic energy output from the output end of the manpower input device (101) is transmitted to the input end of the constant directional rotation output transmission device with same speed ratio (102), while the mechanical output power in constant rotating direction being exported from the output end of the constant directional rotation output transmission device with same speed ratio (102) is used to drive the mechanical functioning device in constant rotating direction, and it includes the constitution of the manpower input device (101) being driven by both or one of the human hand or foot for positive or reverse rotation and having the constant directional rotation output transmission device with same speed ratio (102) with the input end whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive the rotating type mechanical functioning device (108) such as the fluid pump, or fan, or flywheel of inertia storage, or other manpower driven rotating type mechanical functioning device (108).

9. A drive device with human power bidirectional input in constant rotary direction and same speed ratio, wherein it can be further through the manpower to provide positive or reserve rotational kinetic energy to the input end of the manpower input device (101), and the rotational kinetic energy output from the output end of the manpower input device (101) is transmitted to the input end of the constant directional rotation output transmission device with same speed ratio (102), while the constant directional rotation output being exported from the output end of the constant directional rotation output transmission device with same speed ratio (102) is used to drive the power generator (109), and it includes the constitution of the manpower input device (101) being driven by both or one of the human hand or foot for positive or reverse rotation and having the constant directional rotation output transmission device with same speed ratio (102) with the input end whereof to directly receive or via the transmission device (104) to receive the rotational kinetic energy output from the manpower input device (101), and then via the output end of the constant directional rotation output transmission device with same speed ratio (102) to perform constant directional rotation output, whereby the output rotational kinetic energy is directly or via the transmission device (104) to drive rotating type power generator (109), while the power generator (109) can be further optionally installed with the relevant operative control device (110) and the electrical circuit switches or protective devices (111) as needed.

10. A drive device with human power bidirectional input in constant rotary direction and same speed ratio, wherein it is applied to drive the power generator (109) that further combines the loading wheel train (103) and the power generator (109) as an integrally structure, and it includes the constitution of the manpower input device (101) being driven by both or one of the human hand or foot for positive or reverse rotation, and the rotational kinetic energy output from the output end of the manpower input device (101) is directly or via the transmission device (104) transmitted to the input end of the constant directional rotation output transmission device with same speed ratio (102), and then is outputted in the constant rotational direction from the output end of the constant directional rotation output transmission device with same speed ratio (102) for driving the power generator (109), whereby the power generator (109) and the loading wheel train (103) is combined integrally, or the power generator (109) is directly constituted by the loading wheel train (103) as part of the power generation structure; the power generator (109) can be further optionally installed with the relevant operative control device (110) and the electrical circuit switches or protective devices (111) as needed.

11. A drive device with human power bidirectional input in constant rotary direction and same speed ratio, wherein it is further installed with the power generator (109) which is directly driven or driven via the transmission device (200) by the loading wheel train (103) when applied to the manpower driven carrier, wherein it includes the constitution of the manpower input device (101) being driven by both or one of the human hand or foot for positive or reverse rotation, and the rotational kinetic energy output from the output end of the manpower input device (101) is directly or via the transmission device (104) transmitted to the input end of the constant directional rotation output transmission device with same speed ratio (102), and then is outputted in the constant rotational direction from the output end of the constant directional rotation output transmission device with same speed ratio (102) for driving the loading wheel train (103), thereby to drive the power generator (109) by the loading wheel train (103), while the power generator (109) is externally installed to be subject to be driven by the loading wheel train (103), whereby the power generator (109) can be further optionally installed with the relevant operative control device (110) and the electrical circuit switches or protective devices (111) as needed; the present invention is especially applied to a bidirectional pedaling bicycle or to a bidirectional pedaling exercise device for lower limbs bidirectional pedaling, thereby to widen the use of muscles and change the muscle strength and density, and obtain the following advantages:
1) reducing injuries caused by overuse of partial muscles and joints;
2) working or training the muscles and joints seldom being used;
3) avoiding the joints from impact caused by the inertia of the load because of the instant reverse rotation of the load at the reversely pedaling moment.
above advantages can be applied to various bidirectional manpower driving using different muscle groups; especially when apply the bidirectional pedaling driving to bicycles or pedaling exercise devices, the difference of the muscle groups using for bidirectional pedaling is larger, that makes the said advantages and their effects more obvious.
